(19) United States
(12) Patent Application Publication
(10) Pub. No.: US 2001/0035334 A1
(43) Pub. Date: Nov. 1, 2001

(54) Keyboard comprising a dome foil

(76) Inventors: Magnus Andersson, Hjarup (SE); Pernilla Jonsson, Malmo (SE)

Correspondence Address: Stanley R. Moore, Esq., JENKENS & GILCHRIST, P.C., 1445 Ross Avenue, Suite 3200, Dallas, TX, 75202-2799, US

(21) Appl. No.: 09/848,796

(22) Filed: May 4, 2001

Related U.S. Application Data
(60) Provisional application No. 60/207,705, filed on May 26, 2000.

(30) Foreign Application Priority Data
May 24, 2000 (EP) 00610051-5

(51) Int. Cl. H01H 13/70

(52) U.S. Cl. 200/5 A

(57) ABSTRACT

A keyboard for an electronic device, said keyboard comprising a front plate (2) and at least one key (1) extending through an aperture in the front plate (2), said key (1) having a shoulder (8) that is wider than one aperture in the front plate (2). The keyboard further comprising a dome foil (3) having a carrier part (11) and at least one collapsible dome (4) connected to the carrier part (11) by an elastically deformable portion hat is more liable to deformation than the dome (4) itself when a pressure is applied to a top surface of the dome (4). The dome (4) is positioned underneath the key (1) that abuts the dome (4). When no external pressure is applied to the key (1), the dome foil (3) is arranged in such a relationship with the key (1), that the elastically deformable portion is elastically deformed, such that the key (1) is forced against the front plate (2) by the dome foil (3).

The invention relates to a keyboard for an electronic device, said keyboard comprising a front plate and at least one key extending through an aperture in the front plate, said key having a shoulder that is wider than the aperture in the front plate, said keyboard further comprising a dome foil having a carrier part and at least one collapsible dome connected to the carrier part by an elastically deformable portion that is more liable to deformation than the dome itself when a pressure is applied to a top surface of the dome, said dome being positioned underneath the key that abuts the dome.

The invention also relates to an electronic device provided with such a keyboard.

U.S. Pat. No. 3,898,421 discloses a keyboard of this type comprising a dome foil provided with domes of a double dome type comprising a central dome and a peripheral dome connected annularly to the rim of the central dome. When a pressure is applied to the central dome, e.g. by providing an external pressure to a key positioned above the dome, the peripheral dome collapses first, thereby contacting electrodes provided underneath the dome. A continued pressure on the key causes the central dome eventually to collapse. It should be noted that the peripheral dome as well as the central dome undergoes sudden flexural deformation due to the pressure applied and that the electric circuit is closed when the peripheral dome collapses. The subsequently and sudden collapse of the central dome is said to minimize wear of the keyboard.

DE-C2-25 59 681 discloses another keyboard comprising a dome foil. This dome foil comprises a carrier part and single domes that are formed in one piece with the carrier part and connected thereto via strips formed in the dome foil. The domes are collapsible and each dome is designed to undergo sudden flexural deformation when a pressure is applied to the top of the dome by a key positioned above the dome.

Each key of the keyboard is positioned above a dome of the dome foil and is held laterally in this position by a part of the key extending through an aperture provided in the front of the keyboard. Vertically the key is held between the dome and the front of the keyboard by means of the dome at the lower end and, at the upper end, by a shoulder provided at the key, said shoulder being engageable with the rear side of the front of the keyboard.

In the keyboards mentioned above, each dome of the dome foil is designed in such a way that it undergoes sudden flexural deformation when a pressure is applied to the top of the dome. In order to ensure that the dome does not unintentionally undergo sudden flexural deformation, the dome should be fully unstressed when the key above the dome is not activated. Even a slightly pre-tensioned dome of the above type may be causes to flex or collapse if a small, unintended pressure is applied to the dome via the key above it.

Keyboards of the above-mentioned type provided with a dome foil are therefore manufactured under manufacturing tolerances that allow the domes to be fully unstressed when the keys are not activated, i.e. the distance between the dome top and the rear side of the front of the keyboard is larger than the height of the key part that is positioned between the dome top and the rear side of the front of the keyboard. In other words, mechanical play exists between the key and the front of the keyboard.

Due to this mechanical play the keys are only held loosely between the dome foil and the rear side of the front of the keyboard, and the keys are therefore allowed to rattle, if the keyboard is moved or shaken. Furthermore, the positions of the keys in relation to the front of the keyboard are not well defined, since they can be positioned against the rear side of the front of the keyboard or against the dome foil or anywhere there between.

If the keyboard is a part of e.g. a mobile telephone rattling of the keys is most undesirable and it is an object of the present invention to provide a keyboard of the type mentioned in the opening paragraph in which the rattling is eliminated and in which the position of the keys in relation to the front of the keyboard is well defined.

This is achieved by arranging the keyboard in such a way that when no external pressure is applied to the key, the dome foil is arranged in such a relationship with the key, that the elastically deformable portion is elastically deformed, such that the key is forced against the front plate by the dome foil.

Thereby the key will be firmly held between the dome foil and the rear side of the front plate, since the dome foil provides a constant pressure on the key to force it against the rear side of the front plate. Because the key is under constant pressure, no rattling is allowed to occur.

In a preferred embodiment the elastically deformable portion of the dome foil has a shape of an annular collar connected to the dome rim and to the carrier part. This structure can be obtained by simple manufacturing methods such as vacuum forming without use of any other manufacturing methods.

In an alternative embodiment the elastically deformable portion of the dome foil comprises a number of individual strips provided between the dome rim and the carrier part. This embodiment calls for a more complicated manufacturing method, but a better key pressure characteristic may be achieved since the elasticity of the elastically deformable portion can be adjusted by varying the width of the strips.

The dome rim is preferably elevated so a plane above the plane of the carrier part such that when a key is pressed downwards, the elastically deformable portion is deformed until the dome rim abuts a surface which may be provided with electrical terminals. This position corresponds to the position of the dome rim according to the prior art.

Preferably the underside of the dome is electrically conductive, and it is positioned above electrical terminals that can be electrically connected by the dome when an external pressure is applied to the key causing the dome to flex. The dome preferably undergoes a sudden flexural deformation when it flexes.

In most cases a plurality of keys and domes are provided in the keyboard.

The keyboard is especially suitable for use in mobile electronic devices, such as a mobile telephone.

It shall be emphasised that the term “comprise/comprising” when used in this specification is taken to specify the presence of stated features, integers, steps or components but does not preclude the presence or addition of one or more other features, integers, steps components or groups thereof.

The invention will be described in detail in the following with reference to the drawings in which

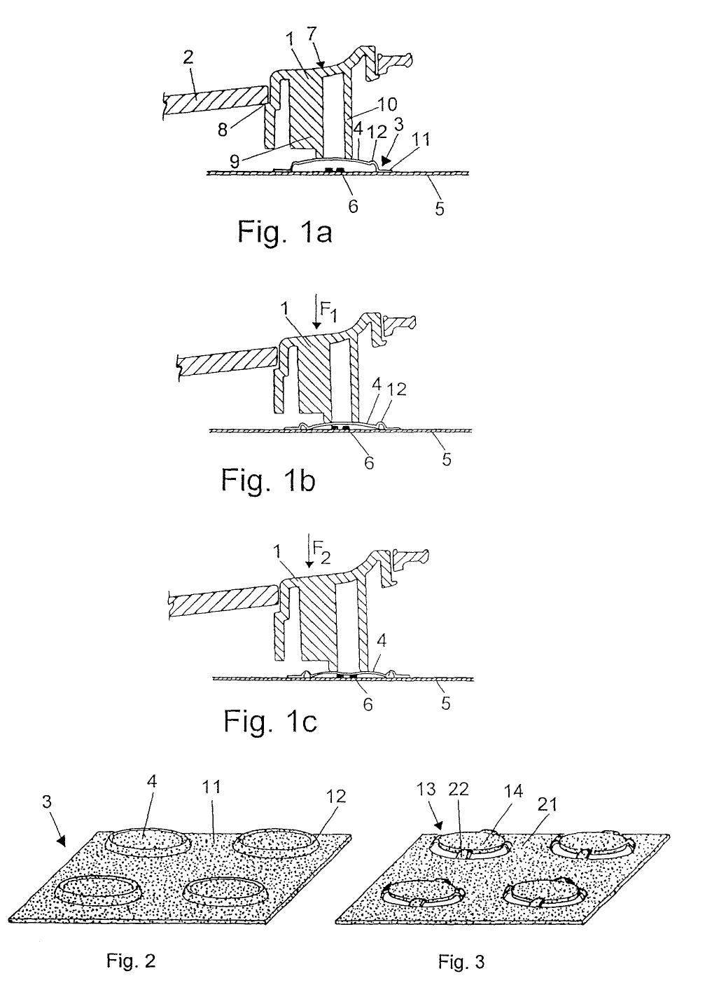

FIGS. 1a-1c show a part of a keyboard according to the invention showing the key in three different positions,

FIG. 2 shows a dome foil used in the keyboard shown in FIGS. 1a-1c, and

FIG. 3 shows an alternative design of a dome foil for use in a keyboard according to the invention.

FIG. 1a shows a part of a keyboard according to the invention, said part comprising a key 1, a front plate 2, a dome foil 3 comprising a collapsible dome 4 and a PCB (Printed Circuit Board) 5 provided with electrical terminals 6 that are to be electrically connected when the key 1 is depressed.

The key 1 has a press surface 7, preferably provided with a number or a sign, and extends through an aperture in the front plate 2. A shoulder 8 is provided on the key 1, said shoulder abutting the rear side of the front plate 2 when the key is in its initial position shown in FIG. 1a. The shoulder 8 determines the outermost extension of the key 1 through the aperture in the front plate 2. The key 1 is further provided with backwards extending ribs 9, 10 that abut the dome 4.

The dome foil 3 comprises a carrier part 11 and a dome 4 that is formed integrally with the carrier part 11 and is connected to this via an elastically deformable portion. The dome 4 is provided with an electrically conducive underside and is therefore able to electrically connecting the two electrical terminals 6 provided at the PCB when the dome 4 are forced to collapse as described later. The elastically deformable portion has in the shown embodiment a shape of an annular collar 12 connected to the dome rim and to the carrier part 11. The annular collar is designed in such a way that it is more liable to deformation than the dome 4.

The carrier part 11 of the dome foil 3 is positioned on the top surface of the PCB 5 and the dome is raised in relation to the PCB 5 via the annular collar 12.

When the dome foil 3 is in its relaxed state, the distance between the dome 4 and the rear side of the front plate 2 is slightly less than the extend of the key part that is positioned between the dome 4 and the rear side of the front plate 2. Therefore, when the key is mounted as shown in FIG. 1a, the annular collar 12, which is more liable to deformation than the dome 4, is slightly elastically deformed and forces the key 1 against the rear side of the front plate 2. The key 1 is thereby held firmly between the dome 4 and the rear side of the front plate 2 and no rattling can occur.

In order to operate the key 1, a downwardly extending force F₁ is applied to its press surface 7. The downwardly movement of the key 1 causes the annular collar 12, which is more liable to deformation than the dome 4, to deform until the rim of the dome 4 engages the PCB as shown in FIG. 1b.

The dome 4 has not collapsed yet and the electrical terminals 6 are not electrically connected.

By applying an additionally downwardly extending force F₁ to the key 1, the dome 4 collapses or flex downwards until its electrically conducting underside interconnects the two electrical terminals 6 provided on the PCB. This is shown in FIG. 1c.

Since the rim oft the dome 4 already engages the PCB 5 under influence of the force F₁, the annular collar 12 does not deform any further when applying the additional force F₁. The only possible deformation is flexural deformation of the dome 4 which causes the electrical terminals 6 to be electrically connected because the electrically conducting underside of the dome 4 engage both electrical terminals 6. The dome 4 is preferably designed such that it undergoes a sudden flexural deformation which gives the user a feelable “click”, indicating that the key 1 has been operated.

When the key 1 is released the dome 4 first flex back to its initial shape forcing the key 1 partly upwards. Immediately afterwards the elastically deformed annular collar 12 forces the key 1 further upwards until the shoulder 8 of the key 1 abuts the rear side of the front plate 2. The key 1 is then in its initial position shown in FIG. 1.

FIG. 2 shows in a perspective view a dome foil 3 having four domes 4 of the type described above. The domes 4 are formed integrally with She carrier part and it can be clearly seen how the domes 4 are connected to the carrier part 11 by annular collars 12. The annular collars 12 are designed such that they are more liable to deformation than the domes 4 themselves as described above.

The dome foil 3 is preferably made in one piece from a plastics material, e.g. by vacuum-forming, and an electrically conducting layer is applied to the underside of each dome.

FIG. 3 shows a dome foil in an alternative embodiment comprising four domes 14 that each is connected to a carrier part 21 by four elastically deformable strips 22 which together constitute an elastically deformable portion that is more liable to deformation than the dome 14 itself.

The dome foil 13 may be manufactured in one piece as the dome foil 3 having the openings between the strips 22 being punched out. However, the dome foil 13 may also be provided with thin metal domes that are glued or welded to the strips 22 which preferably are formed integrally with the carrier part 21, e.g. from a plastics material.

Other modifications than the ones shown and described above are possible without departing from the basic idea of the invention.

1. A keyboard for an electronic device, said keyboard comprising a front plate (2) and at least one key (1) extending through an aperture in the front plate (2), said key (1) having a shoulder (8) that is wider than the aperture in the front plate (2), said keyboard further comprising a dome foil (3; 13) having a carrier part (11; 21) and at least one collapsible dome (4; 14) connected to the carrier part (11; 21) by an elastically deformable portion that is more liable to deformation than the dome (4; 14) itself when a pressure is applied to a top surface of the dome (4; 14), said dome (4; 14) being positioned underneath the key (1) that abuts the dome 4; 14), characterized in that when no external pressure is applied to the key (1), the dome foil (3; 13) is arranged in such a relationship with the key (1), that the elastically deformable portion is elastically deformed, such that the key (1) is forced against the front plate (2) by the dome foil (3; 13).

2. A keyboard according to claim 1, characterised in that the elastically deformable portion of the dome foil (3) has a shape of an annular collar (12) connected to the dome rim and to the carrier part (11).

3. A keyboard according to claim 1, characterised in that the elastically deformable portion of the dome foil (13) comprises a number of individual strips (22) provided between the dome rim and the carrier part (21).

4. A keyboard according to any one of claims 1-3, characterised in that the dome rim is elevated to a plane above the plane of the carrier part (11; 21).

5. A keyboard according to any one of claims 1-4, characterised in that the underside of the dome (4: 14) is electrically conductive, and that it is positioned above electrical terminals (6) that can be electrically connected by the dome (4; 14) when an external pressure is applied to the key (1) causing the dome (4; 14) to flex.

6. A keyboard according to any one of claims 1-5, characterised in that a plurality of keys (1) and domes (4; 14) are provided.

7. An electronic device provided with a keyboard according to any one of claims 1-6.

8. An electronic device according to claim 7, characterised in that the electronic device is a mobile radio station, such as a mobile telephone.
